(19) United States
(12) Patent Application Publication
(10) Pub. No.: US 2012/0180107 A1
(43) Pub. Date: Jul. 12, 2012

(54) GROUP-ASSOCIATED CONTENT RECOMMENDATION

(75) Inventors: Kevin Gammill, Beaux Arts, WA (US); Stacey Law, Redmond, WA (US); Kathryn Stone Perez, Kirkland, WA (US); John Clavin, Seattle, WA (US)

(73) Assignee: MICROSOFT CORPORATION, Redmond, WA (US)

(21) Appl. No.: 12/986,711

(22) Filed: Jan. 7, 2011

(51) Int. Cl. G06F 15/16; G06F 21/00

(52) U.S. Cl. 726/3; 709/204

(57) ABSTRACT

A method of generating content recommendations to groups of users is provided. The method includes establishing a group, determining group-associated characteristics, where such characteristics include preferences independent of any merging, intersection or other combination of individual preferences of the group members, and providing content recommendations to the group based on the group-associated characteristics.

### BACKGROUND

The Internet is awash in solutions for recommending content. When a book is purchased online, the purchaser is prompted with suggestions to buy other books by the same author. Downloading a particular song produces suggestions to buy content purchased by other users that also like the particular song. There is seemingly no end to the purveyors of this service, though all solutions focus in some respect on the individual tastes, and to the exclusion of tastes that might arise in a particularized fashion with respect to a group interaction.

### SUMMARY

Accordingly, a recommendation system and method are disclosed, in which recommendations of consumable items are proposed in response to preferences associated with a group, where individual consumption habits and tastes may play a part, but in many cases, the preferences go beyond and are independent of any merging, intersection or other combination of individual preferences or other known and/or inferred characteristics of the users in the group.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically depicts a computing system for generating and providing group-associated content recommendations.

FIG. 2 depicts an exemplary method of providing group-associated content recommendations.

FIG. 3 depicts an exemplary method of organizing users into groups for which group-associated characteristics and/or preferences are used to provide recommendations for the group.

FIG. 4 depicts implementation scenarios for the method depicted in FIG. 3.

### DETAILED DESCRIPTION

The discussion herein involves group-associated identities and content, consumable item, activity, and/or experience recommendations. As indicated above, in many cases the identity of the group will stand apart from any union or intersection of the tastes of the individual group users. In particular, when people are joined together in a group, the type of content or activities that they are interested in becomes much more dynamic and variable, and as a result of such variability analysis is performed on not just the known preferences of the individuals, but also taking into account known preferences, biographic information, observed habits, specifically input information, or in reality, any suitable source of information about the group members that can be attained. In this way, a suitable recommendation of content, activities, and/or experiences can be made.

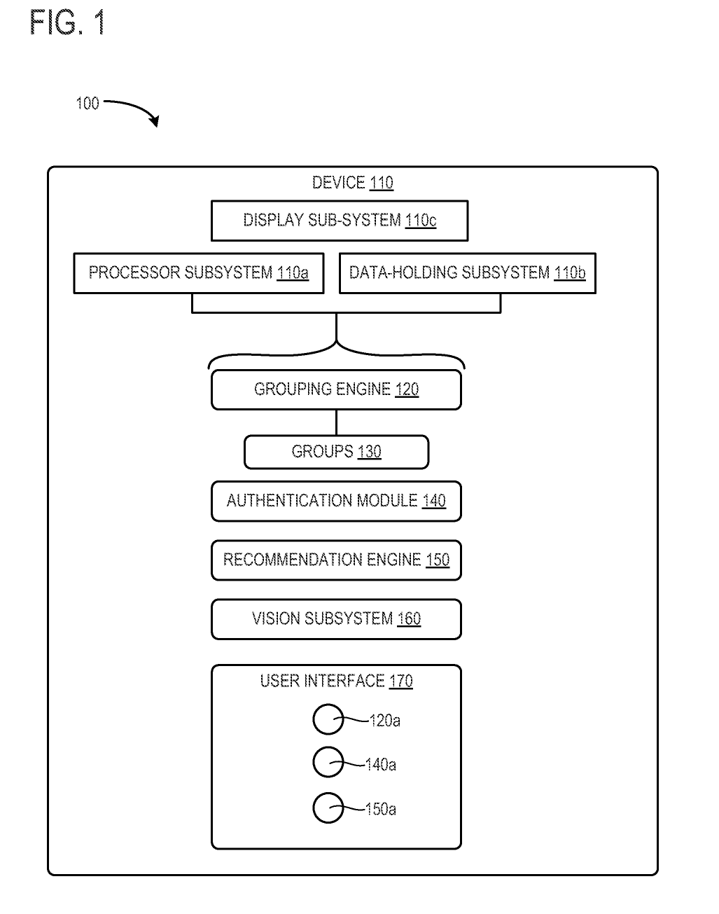

FIG. 1 depicts a system 100 for establishing group identities and using those identities to generate recommendation content and/or recommended consumable items, activities, and/or experiences associated with group identities or contexts. It will be appreciated that content may include any digital media (e.g., games, movies, music, c-books, reminders, video chat) and/or other applications.

In many examples, the systems and methods are implemented using one or more general purpose computers, such as device 110. Device 110 includes a processor subsystem 110a, a data-holding subsystem 110b and display subsystem 110c. Processor subsystem 110a is operatively coupled with data holding subsystem 110b.

When the present discussion refers to a method, it will be assumed that such reference is made in connection with a series of steps or operations that may be carried out through instructions that can be stored (e.g., contained) in data-holding subsystem 110b and executed and instantiated by processor subsystem 110a.

The instructions may be configured to perform various steps, some of which may correspond to one or more structures shown below data-holding subsystem 110b and processor subsystem 110a in FIG. 1. In particular, system 100 may include a grouping engine 120. The grouping engine 120 is operable to facilitate the establishment of groups 130. A group is a collection of two or more users. Group definitions apply also in respect to an individual user in the sense that the system will identify the group as being active or present even if only a single member is authenticated as being present.

In a first example, corresponding to explicit group formation, an individual or group of individuals collectively assert a desire to form or join a group. For example, a social network may present various opportunities for people to affirmatively and explicitly form groups.

In a second example, groups are generated organically through various methods. For example, the desire to form a group can be as implicit as being together in the same room that takes advantage of a system in place to identify individuals (e.g., a vision subsystem 160, voice recognition system, RFID or some other computer based authentication). Then, based on who is present during an interaction, the system can generate a group identity and associate that identity with a context that correlates strongly with the consumption of specific content items or types of content items that are contextually relevant to the individuals that are contextually relevant to the collective group. For example, a group is consuming content together on a Sunday afternoon. All the members are male, and live in Western Washington. The group provides an indication to the system that it wants to watch sports. Accordingly, the system takes into consideration the characteristics of the group including the demographics, location, time/date, as well as the active indication provided by the group to recommend an activity. As a particular example, the system determines that the Seahawks® have a football game on that day during that time, and recommends that content above other content based on the characteristics of the group.

Moreover, the system may be capable of notifying or reacting to a change in the group during a group activity. For example, in an implementation including vision subsystem 160, a “family” group including a mother, a father, and a child may be identified by vision subsystem 160 based on body type identification or the like (or through an active login process). The system recommends family content (e.g., an animated film) based on the analyzed characteristics of the “family” group. During consumption of the family content, vision subsystem 160 recognizes that the child leaves the activity (e.g., leaves the room to go to bed), and the system determines that the characteristics of the group have changed from “family” group to an “adult” group including the mother and the father. Accordingly, the system may notify the adult group of the change and/or recommend different activities based on the characteristics of the new group. For example, the system may recommend a film including content suitable for a mature audience. Note the system may be configured to react to a change in group in any suitable manner.

In many cases, content recommendations and group identity/context become associated with lists of preferences, or with content items that have been particularly satisfactory during past consumption. For example, User A may have a playlist of favorite songs, and User B may have also have a playlist of favorite songs. So a list of group preferences could well include a list that simply combines the contents of both of their playlists. Furthermore the merging of play lists could involve an intersection of common tastes. However, such a scheme might exclude the possibility that the two users might have particularized preferences that only arise when they are together and/or in like groups during an interaction, whether in-person or online.

Thus, the system is operable to either specifically or explicitly generate group-associated characteristics and/or preferences regarding digital content items, or to learn those preferences through various feedback mechanisms that tune results toward overall improvement over time. In particular, the system not only merges known or predefined preferences of each user, the system alternatively or additionally analyzes a wide range of characteristics of the group to suggest shared tastes that the users may not necessarily have as individuals. For example, Jack and Paul always watch Mariners® baseball together, but never watch it on their own. The system may analyze the consumption behavior of each user as well as the characteristics of the group to only recommend Mariners® games for viewing when Jack and Paul are consuming content in a group together.

As another example, a husband only ever watches a romantic comedy with his wife. The preferences of a “couple” group may include romantic comedies, whereas, the preferences of the “husband” group explicitly exclude (or implicitly exclude via viewing behavior) romantic comedies. As such, there will be content that will not be a personal preference that will be part of a group preference. As yet another example, a parent consumes children's content in a group scenario including their child. However, the children's content would not be a personal preference for content (or experiences) for the parent. As yet another example, Joe and Bob get together to listen to music. Joe is a big Springsteen fan, and Bob only ever listens to Elton John. There is no intersection in their preferences, but based on beats and melody analysis of the music, together they may enjoy The Killers.

As yet another example, Paul and Tony play a lot of online games, are both big skiing fans, and like to discuss democratic politics on at a social network. They get together to watch some TV. Instead of trying to find some common ground in the three known preferences, the system knows that it's 6 pm on a Monday in November, and Paul and Tony always watch football during that time slot.

As yet another example, a family group (2 adults in their 40s+2 teens) with no deep history of preferences gets together on a Tuesday evening to watch TV. They system scans available video content and suggest the most likely content for the group based on group-associated preferences (e.g., primetime shows, that exclude NC17 or M ratings, shows ranked by popularity, no kids or sports centric, etc.) to produce a recommendation such as a situational comedy. To elaborate further, the family group is joined by one other user who fits the same general demographic parameters or has similar characteristics, and in response the system offers a pop-up indicator requesting if the group wishes to continue the current activity, or have a new round of preferences determined based on the new group. As an alternative example, the family group is joined by another user having a different demographic or characteristics (e.g., a younger child), and in response the system pauses video playback with a masking screen, and offers a pop-up indicator requesting if it is OK to continue with the current content, or if it needs to start a new round of recommendations based on characteristics adjusted for the additional user.

In some implementations, the system may provide recommendations based on group-associated characteristics or preference of a group of users physically co-located in the same space to consume the same content or participate in the same activity. In some implementations, the system may provide recommendations based on group-associated characteristics or preference of a group remotely located from one another which will share viewing of content synchronously from different locations. In such scenarios the system may provide various online party mode elements to determine preferences and/or characteristics of the group as well as to synchronize content or an activity or an experience shared by the group.

In many cases, it will be desirable to provide a mechanism for determining when users are present as well as identify which users are present in an interaction. In particular, system 100 may include an authentication module 140 configured to determine the presence of specific users. One implementation of authentication module 140 involves identifying a user as a result of a specific login process. In another example, authentication module 140 is coupled with a vision subsystem 160 that is configured to optically detect or otherwise use machine vision to detect the presence of users. In addition to or instead of an optic-based vision system, other methods of automatic detection may be employed, such as audio detection (e.g., voice recognition). A user interface may even be supplied with a learning mechanism by which a user can be authenticated merely through observation of their interaction with device 110 (e.g., through detection of characteristic movements, cadence, pressure or other properties associated with keystrokes, etc.).

The authentication methods and examples described above may be used not only to detect the presence of users (and thus the presence of a group and/or existence of a context) but to also organically assemble user groups. For example if Users A, B, and C are detected together on more than one occasion, the system may infer a group from that and use the group's consumption behavior to begin accumulating preferences associated with the group. Alternatively or additionally, methods and systems described herein may include or be operable to perform analysis on unknown or limited-knowledge users and make intelligent choices about characteristics or attributes of the unknown or guest user and take such characteristics into consideration when providing recommendations for a group including the guest user. For example, the system may recognize 2 of 8 persons present in a group and can provide more generic recommendations than just offering items specific to the 2 identified persons. As another example, the system may recognize the presence of minors in a group based on image analysis via vision subsystem 160, and may tailor recommendations based on the assumed presence of minors.

In general, it will be appreciated that various aspects of system 100 may operate in response to explicit inputs and/or in response to an organic learning function. For example, as previously indicated, groups may be formed explicitly or organically (e.g., assumptions may be made about a group based on instant analysis of the group to provide recommendations). In addition, as explained elsewhere, recommendations may arise as a result of explicit user inputs (e.g., an affirmative “thumbs up” to a particular song), or in response to organic learning through observation of consumption behavior. In many cases, explicit inputs will be received into the system via a user interface (UI) 170. For example, UI elements 120a, 140a, and 150a may be used to apply inputs to the grouping engine 120, authentication module 140, and recommendation engine 150.

Group identification may be performed in various ways. Many of the identification methods involve situations where an identified user is a member of multiple groups/contexts. In such a case, assuming the user is the only user present, the system might determine a group based on the frequency with which the user enters particular contexts. For example, if the user appears most often in a group with three other friends that play particular types of video games, system 100 might infer that this is an appropriate group and preferences to invoke when only that user is present, even though the user may belong to a number of other groups.

In another example, assume User A and User B belong to multiple different groups. If one of the groups includes only the two users, with other groups containing more than just those two users, it might be inferred that when only those two users are present, that the smallest group is the one to invoke.

In still another example, assume that a relatively large number of users belong to a group that regularly assembles remotely online to play a particular online game. Assume further that a small subset of those users gather online to discuss books that they have read. Assume still further that one of the book club members nearly always participates online in the book club, but only rarely plays the online game. It can then be assumed that when that small subset gathers remotely online, it is probably for the book club because one of the members of this subset rarely plays the online game even though they are a member of that group. From the herein described methods, it will be appreciated that any number of methods may be used to resolve such ambiguous situations. The foregoing are non-limiting examples.

Still further, the systems and methods may be implemented to authenticate unidentified users. For example, if four of five members of a group have been identified, and a fifth unidentified person is present (for example, as detected by a depth camera) then, in some implementations, it can be presumed that the unidentified person is in fact the fifth member of the group. Moreover, in some cases, the system takes into account any potential constraints that the fifth member might bring. For example, the group of four may have age concerns different from the group of five (e.g., the fifth member may be a child), and the system may block specific content upon recognizing the fifth member. In some cases, as the number of users in a group that are not recognized increases recommendations for specific group content dilutes back towards a recommendation for more generic content.

As indicated above, various types of content, consumption item, activity, and/or experience recommendations may become associated with a group/context. In one example, content recommendations are provided in response to one or more group members “seeding” the recommendation function by providing ratings or other indications that certain content is desirable. Recommendations can then proceed based on identification of similar content, or of other content that is favored by consumers of the content that has already been rated by the group or otherwise indicated as being desirable to the group. In some implementations, in a scenario where there is more seeding information about one user that about other user of a group, recommendations may be based on such information. In some implementations, recommendations may be diluted across the number of user involved so that one user's preferences do not dominate simply because the system knows more about that user than the other users of the group.

In addition to or instead of seeding, the group consumption behavior may be observed over time with the learned preferences then being used in various ways to generate recommendations. Furthermore, in some implementations, consumption behavior for the group can be derived, at least in part, from other groups having similar characteristics. Alternatively or additionally, consumption behavior for the group can be derived, at least in part, from previous consumption behavior of members or subsets of members of the group.

Specifically, as shown in FIG. 1, system 100 may include a recommendation engine 150. Recommendation engine 150 may be responsive to explicit inputs (e.g., from UI element 150a) and or to any activity occurring in the system that can be monitored to gather intelligence for leveraging in the generating of future recommendations. In addition to the many other examples cited herein, one way of observing group activity to improve the quality of recommendations is to observe the activity of the group in social networking environments. For example, in addition to gathering to play online games, members of a particular group may engage in online discussions or other interactions that shed light on what content recommendations might be appropriate for the group. In some implementations, users may tailor which information may be made available to recommendation engine 150 for providing recommendations for groups including the user. Moreover, a user may make available different information for different groups to manipulate recommendations for the different groups. Correspondingly, recommendation engine 150 may take into consideration different user information for different group recommendations based on input provided by the user.

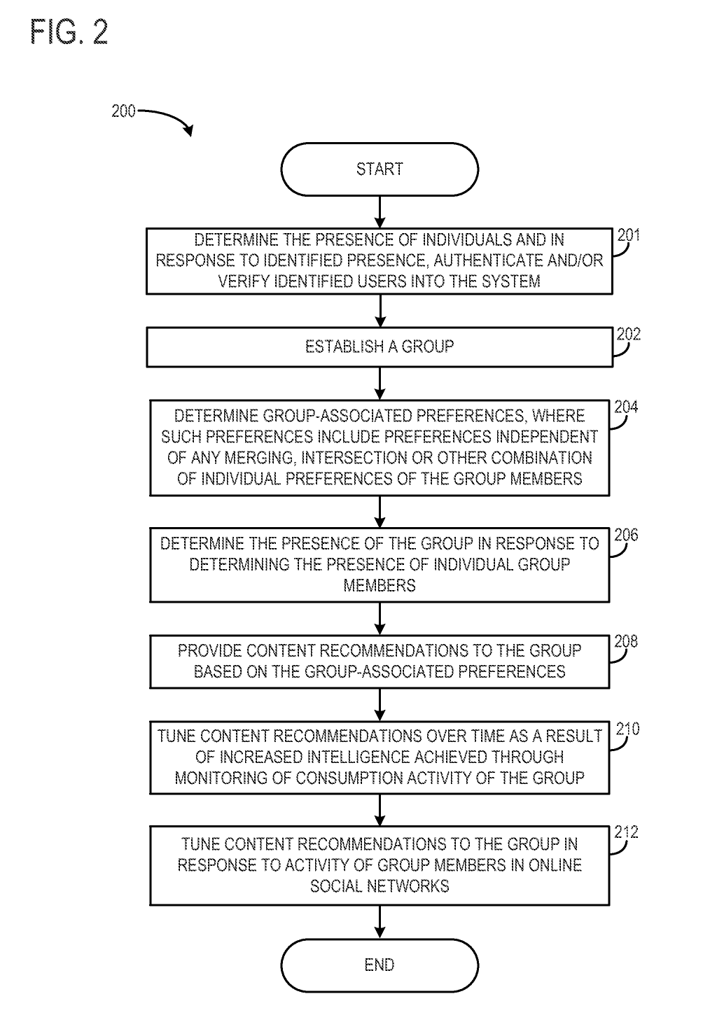

FIG. 2 shows a method 200 of providing group-associated content recommendations. Method 200 may be implemented by the system, device, components, etc., described above or may be implemented via other suitable systems, devices, components, etc.

At 201, method 200 may include determining the presence of individuals and in response to identifying individuals, authenticating or verifying identified users into the system. However, in other embodiments step 201 may not be included in the method.

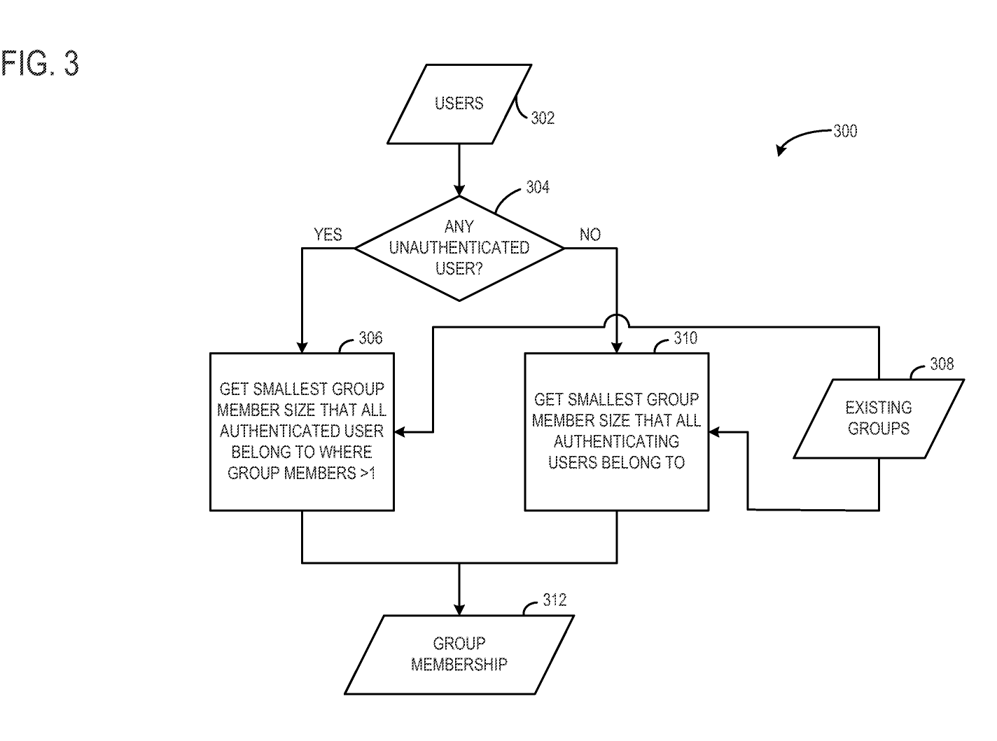

At 202, method 200 includes establishing a group. In sonic examples, the group may be established dynamically and organically through observation of multi-person interactions. Moreover, the group may be established through collection assertion, verified through individual affirmation, of a desire to form a group in some examples. Group establishment will be discussed in further detail below with reference to FIG. 3.

Next, at 204 the method 200 includes determining group-associated characteristics and/or preferences, where such preferences include preferences independent of any merging, intersection or other combination of individual preferences of the group members. The characteristics may include the results of analysis of data aggregated about the users of the group. In some examples, the characteristics and/or preferences are determined organically and dynamically in response to monitoring of group activity. In some examples, the preferences are derived from preferences of other groups having the same or similar characteristics. In some examples, the characteristics and/or preferences are derived from past consumption behavior of individual members or a subset of members of the group. Additionally in some examples, the characteristics or preferences may be determined in response to explicit inputs from the user. Still further in some examples, the characteristics or preferences may be established through observations of activity in online social networks, as a result of determining that there is elevated interaction with respect to a particular topic or content item, and/or in response to binary positive or negative inputs or a lack thereof from users of social networks. In some examples, preferences may be established in response to binary positive or negative inputs from mechanisms including tagging, social networks, blogging, voice recognition, and body posture.

At 206, method 200 includes determining the presence of the group in response to determining the presence of individual group members. Next, at 208, the method 200 includes providing content recommendations to the group based on the group-associated characteristics and/or preferences and at 210, includes tuning content recommendations over time as a result of increased intelligence achieved through monitoring of consumption activity of the group. At 212, method 200 may include tuning content recommendations to the group in response to activity of group members in online social networks. However, in other embodiments step 212 may be omitted from the method.

By treating a group, once determined, like an individual in terms of group-associated characteristics and/or preferences, preferences can be derived from other groups having similar characteristics, in addition to applying intersection/union techniques.

FIG. 3 shows an embodiment of a method 300 for establishing a group of user. Method 300 may be implemented by the system, device, components, etc., described above or may be implemented via other suitable systems, devices, components, etc. For example, method 300 may be implemented, at least in part, by grouping engine 120 executable by computing device 110 of computing system 100 shown in FIG. 1.

At 302, method 300 may include identifying users that are present to consume content, participate in an activity or experience, etc. Present users may be co-located in the same space, remotely located online, or a combination thereof. In some implementations, present users may be identified as authenticated users or “guests”.

At 304, it may be determined if any of the present users are unauthenticated users. In some implementations the determination may be made via an active login process. In some implementations, the determination may be made via leaned characteristics of a user or users, such as learned through an audio or visual recognition step. If it is determined that any unauthenticated users are present method 300 moves to 306. Otherwise, method 300 moves to 310.

At 306, method 300 may include identifying a smallest size existing group of authenticated users selected from all existing groups (received at 30$) that includes all of the present authenticated users and has a group membership greater than one (i.e. not a group only including an individual member).

At 310, method 300 may include identifying a smallest size existing group of authenticated users selected from all existing groups (received at 308) that includes all of the present authenticated members.

At 312, method 300 may include forming a group of the present users with characteristics or preferences derived from the existing group selected in method step 306 or 310.

The above method assumes that if one or more authorized users are present, they are part of a larger group subsequently providing recommendations based on that group as a group rather than an aggregate of the two individuals. What group the authorized user(s) are part of is determined by the smallest sized group, in terms of members, that contains the both authorized user(s).

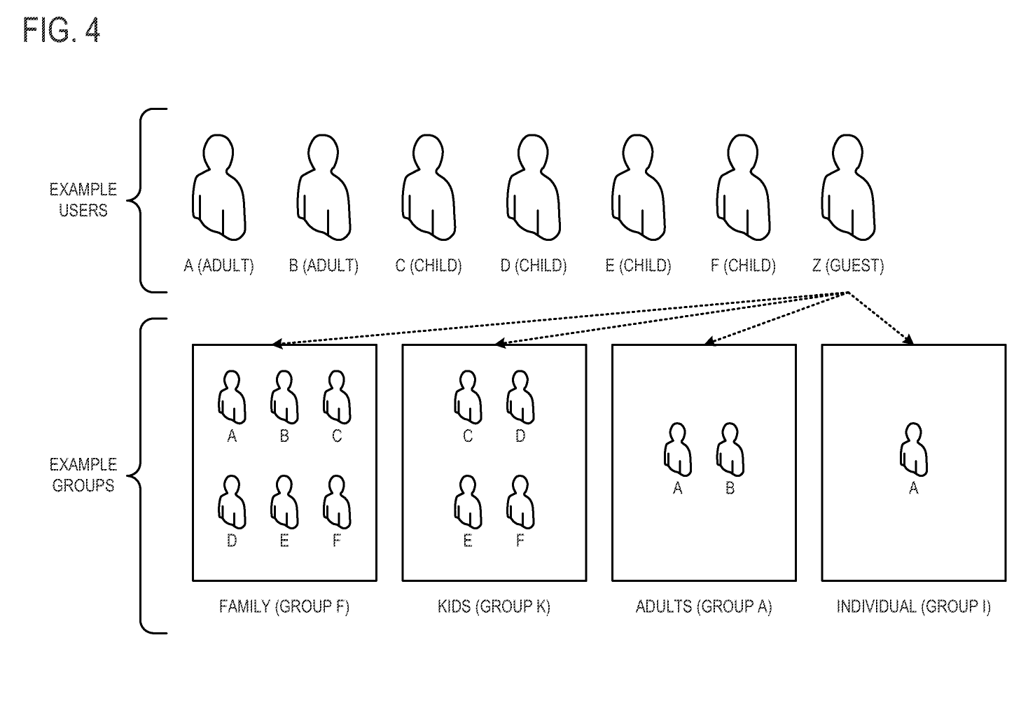

FIG. 4 shows implementation scenarios for method 300 that comprises a family of six that contains two adults (A and B), and four children (C, D, E, and F), with Family (Group F), Kids (Group K), Adults (Group A), and Individual A (Group I) groups defined. Method 300 assumes that if one or more people are consuming content, they are part of one or more groups of the same or larger size in terms of members. Method 300 identifies a group selected from existing groups that is identified as having the fewest number of members and includes the authorized user(s) as the group that is “in use.” In other words, characteristics or preferences of the group “in use” may be applied to the present users and may be used, at least in part, for recommendations for the group of present users. The table below provides a number of examples of authenticated users and corresponding groups that result from implementing method 300:

| Authorized User(s) | Group |
|---|---|
| A | Individual (Group I) |
| B | Adults (Group A) |
| A + B | Adults (Group A) |
| A + C | Family (Group F) |
| B + C | Family (Group F) |
| C + D + E | Kids (Group K) |
| A + D | Family (Group F) |
| B + F | Family (Group F) |

Furthermore, consider a scenario in which there are one or more authenticated users and one or more unauthenticated users (“guests”). For example, guest (Z) may be added to any of the above groups. In those situations, method 300 behaves similarly to when only authenticated users are present with the only difference being individual groups (e.g. groups of only one member, such as Group I) are ignored when determining what group to base recommendations on. As such, recommendations may not be biased toward the preferences of a single user in a group when only one user is authenticated. Instead, recommendations may be diluted to consider all of the members of the group. In the case of adding guest (Z) to Individual (Group I), recommendations may be provided differently in different implementations. In some implementations, generic recommendations may he provided for the group. In some implementations, intelligent inferences may be made about characteristics of guest (Z) based on detection by the system (e.g., detecting short stature may infer that guest (Z) is a child), and such inferences may be taken into consideration when providing recommendations. In some implementations, recommendation for the group may be based on characteristics and/or preferences of adult (A). Note the above method is but one of many example implementations for grouping members, and other implementations are within the scope of this disclosure.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may he changed.

The subject matter of the present disclosure includes all novel and nonobvious combinations and subcombinations of the various processes, systems and configurations, and other features, functions, acts, and/or properties disclosed herein, as well as any and all equivalents thereof.

What is claimed is:

1. A method of generating content recommendations to groups of users, comprising:
establishing a group;
determining group-associated characteristics, where such characteristics include preferences independent of any merging, intersection or other combination of individual preferences of the group members; and
providing content recommendations to the group based on the group-associated characteristics.

2. The method of claim 1, where the group is established dynamically through observation of multi-person interactions.

3. The method of claim 1, where the group is established through collection assertion, verified through individual affirmation, or a desire to form a group.

4. The method of claim 1, where the characteristics are inferred dynamically in response to monitoring of group activity.

5. The method of claim 1, where the characteristics are determined in response to explicit inputs from the user.

6. The method of claim 1, where the characteristics are established through observations of online user activity.

7. The method of claim 6, where the characteristics are established as a result of determining that there is elevated interaction with respect to a particular topic or content item.

8. The method of claim 6, where the preferences are established in response to binary positive or negative inputs from mechanisms including tagging, social networks, blogging, voice recognition, and body posture.

9. The method of claim 1, further comprising:
determining the presence of individuals; and
in response to identifying the presence of individuals, authenticating and/or verifying identified users into a system.

10. A computing system for generating content recommendations, comprising:
a processor subsystem operatively coupled with a data-holding system which contains recommendation instructions executable by the processor subsystem to:
establish a group;
determine group-associated preferences, including preferences that are independent of any merging, intersection or other combination of individual preferences for digital content items; and
provide content recommendations to group members based on the group-associated preferences.

11. The computing system of claim 10, where the instructions are configured to dynamically establish the group based on observations of multi-person interactions.

12. The computing system of claim 10, where the instructions are configured to establish the group in response to collective desire, as affirmed through individual affirmation, to form a group.

13. The computing system of claim 10, where the instructions are operable to dynamically determine the group-associated preferences in response to observation of user consumption activity.

14. The computing system of claim 10, where the instructions are operable to determine the group-associated preferences in response to explicit user inputs relating to digital content items.

15. The computing system of claim 10, where the e instructions are operable to determine the group-associated preferences through monitoring of social network activity.

16. The computing system of claim 15, where the instructions are operable to establish a preference in response to elevated interaction relating to a digital content item, group of digital content items or topic.

17. The computing system of claim 15, where the instructions are operable to establish a preference in response to binary indications of preference or lack thereof in respect to a digital content item, group of digital content items or topic.

18. The computing system of claim 10, further comprising an authentication module configured to determine presence of users, and in response verify and/or authenticate present users into the system.

19. A method of generating content recommendations to groups of users, comprising:
establishing a group;
determining group-associated preferences, where such preferences include preferences independent of any merging, intersection or other combination of individual preferences of the group members;
determining the presence of the group in response to determining the presence of individual group members;
providing content recommendations to the group based on the group-associated preferences; and
tuning content recommendations over time as a result of increased intelligence achieved through monitoring of consumption activity of the group.

20. The method of claim 19, further comprising tuning content recommendations to the group in response to activity of group members in online social networks.
